(19) United States
(12) Patent Application Publication
(10) Pub. No.: US 2002/0018616 A1
(43) Pub. Date: Feb. 14, 2002

(54) Optical channel shared protection ring

(76) Inventor: Ming-Jun Li, Horseheads, NY (US)

Correspondence Address: CORNING INCORPORATED, SP-TI-3-1, CORNING, NY, 14831

(21) Appl. No.: 09/861,003

(22) Filed: May 19, 2001

Related U.S. Application Data
(60) Provisional application No. 60/205,749, filed on May 19, 2000.

(51) Int. Cl. G02B 6/28; G02B 6/35

(52) U.S. Cl. 385/24; 385/16

(57) ABSTRACT

A four-fiber or two-fiber, two-wavelength optical channel switched protection ring architecture uses nodes having as small as 2×2 optical switch fabrics in conjunction with as small as 1×3 optical or electronic switches and bridges. The nodes are adapted to provide non-adjacent node protection switching, optionally with no single point of failure.

This application claims the benefit of priority (under 35 U.S.C. § 120) of U.S. Provisional Application No. 60,205,749, filed May 19, 2000.

### BACKGROUND

1. Field of the Invention

The present invention relates to optical channel shared protection rings, and particularly to optical channel shared protection rings employing optical switch fabrics and utlilizing four fibers, or two fibers each with at least two wavelengths, providing four paths around the ring.

2. Technical Background

Optical shared protection rings offer the possibility lowering telecommunications network costs by extending optical reach while performing protection switching all or in part in the optical domain. One restraint on the implementation of optical shared protection rings is the complexity of the switch fabrics that may be called for. It is thus highly desirable to find a simple yet effective node architecture for optical shared protection rings.

### SUMMARY

According to one aspect of the present invention, a four-fiber (or two-fiber, two-wavelength) optical channel switched protection ring architecture uses nodes desirably having 2×2 optical switch fabrics in conjunction with small optical or electronic switch and bridges. Although larger fabrics may be used, 2×2 fabrics generally offer the lowest loss for express channels, an important parameter for an optical ring node. The nodes are adapted to provide non-adjacent node protection switching. Adjacent node switching is not desirable in optical protection, because the protection path can be much longer than non-adjacent node switching. For non-adjacent node switching, since loop-back operation is not needed, optical switch fabrics smaller than 4×4 can be used.

According to another aspect of the invention, the node avoids any single point of failure. This is achieved in part through the inclusion of excess add and drop ports.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principles and operation of the invention.

### BRIEF DESCRIPTION OF THE DRAWINGS

FIG. 1 is a schematic diagram of an embodiment of a node of an optical shared protection ring according to the present invention;

FIG. 2 is a schematic diagram of another embodiment of a node of an optical shared protection ring according to the present invention;

FIG. 3 is a schematic diagram of an embodiment of an optical shared protection ring employing an architecture according to the present invention, shown in standard operation;

FIGS. 4, 5, 6, and 7 are each a schematic diagram of the operating state of an embodiment of the node A, B, D, and C of FIG. 3, respectively;

FIG. 8 is a schematic diagram of an embodiment of an optical shared protection ring employing an architecture according to the present invention, shown in the case of a fiber cut or break;

FIGS. 9, 10, and 11 are each a schematic diagram of the operating state of an embodiment of the node A, B, and D of FIG. 8, respectively;

FIG. 12 is a schematic diagram of an embodiment of an optical shared protection ring employing an architecture according to the present invention, shown in the case of a cable cut or break;

FIGS. 13, 14, and 15 are each a schematic diagram of the operating state of an embodiment of the node A, B, and D of FIG. 12, respectively;

FIG. 16 is a schematic diagram showing the operation of a node of an optical shared protection ring according to the present invention under the condition of failure of long-reach optical transmitter and receiver pair;

FIG. 17 is a schematic diagram showing the operation of a node of an optical shared protection ring according to the present invention under the condition of failure of optical switch fabrics and associated links from the switch fabrics to the electronic switch board;

FIG. 18 is a schematic diagram of yet another embodiment of a node of an optical shared protection ring according to the present invention, an embodiment avoiding a single point of failure;

FIG. 19 is a schematic diagram of still another embodiment of a node of an optical shared protection ring according to the present invention, in another embodiment avoiding a single point of failure;

FIG. 20 is a schematic diagram of an additional embodiment of a node of an optical shared protection ring according to the present invention;

FIG. 21 is a schematic diagram of another additional embodiment of a node of an optical shared protection ring according to the present invention;

FIG. 22 is a schematic diagram of still another additional embodiment of a node of an optical shared protection ring according to the present invention;

FIG. 23 is a schematic diagram of yet another additional embodiment of a node of an optical shared protection ring according to the present invention;

FIG. 24 is a schematic diagram of additional embodiment of a node of an optical shared protection ring according to the present invention; and

FIG. 25 is a schematic diagram of one more embodiment of a node of an optical shared protection ring according to the present invention.

### DETAILED DESCRIPTION OF THE INVENTION

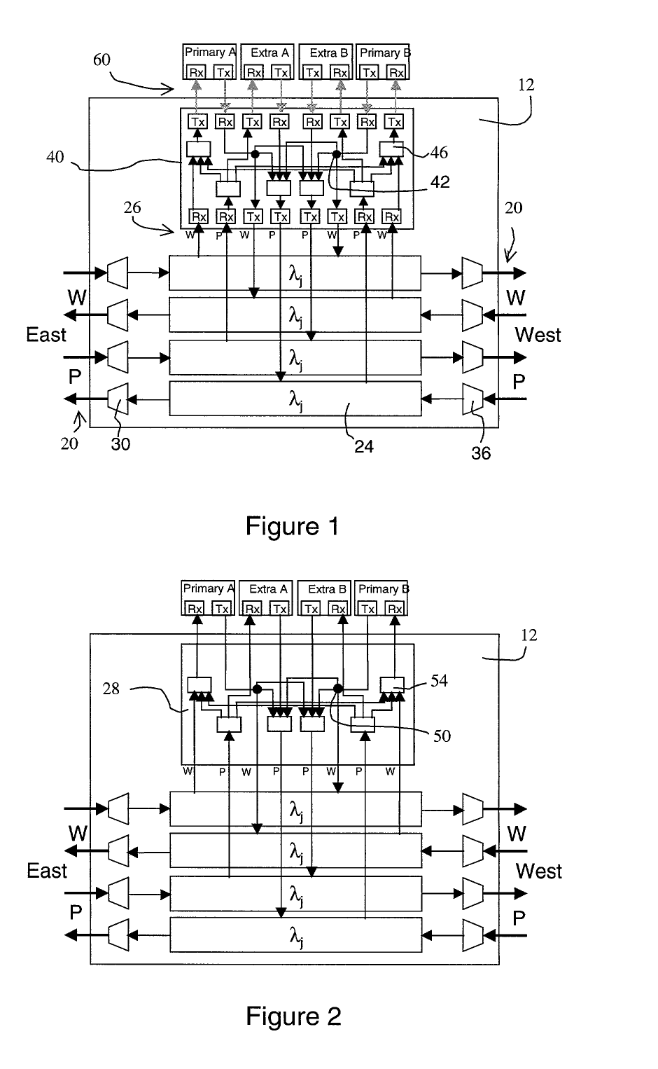

FIG. 1 shows a schematic diagram of a node 12 employing 2×2 optical switch fabrics 24, together with 1×3 electrical switches 46 and 1×3 electrical bridges 42 in electronic switch board 40. Each 2×2 optical switch is connected to one of the four fibers 20 through a mux 30 and a demux 36, and to one transmitter and receiver within the electronic switch board 40. In this way, the 2×2 switch can pass traffic through the node or add traffic to and drop traffic from the ring. For each optical channel (each separate wavelength), four 2×2 optical switch fabrics are needed.

Note that in FIG. 1, only one optical channel of wavelength λᵢ is shown. For n optical channels, 4n 2×2 optical switch fabrics are required, which would typically be stacked perpendicular to the plane of the figure. Alternatively, serial, rather than parallel, demutliplexing and multiplexing could be used. Whatever the multiplexing scheme employed, each optical channel from the crossconnects is connected to an electronic switch board 40. The electronic switch board 40 includes six 1×3 electronic switches 46, two 1×3 electronic bridges 42, four transmitter and receiver pairs 26 made for ITU grade long reach optical signals, and four transmitter and receiver pairs 60 made for 1300 nm short reach optical signals.

For a wavelength λⱼ, four clients can be supported: two primary clients Primary A and Primary B that are protected, and two extra clients Extra A and Extra B that are not protected. In this node design, the working channel and its corresponding protection channel are on the same wavelength. As no wavelength conversion is required in protection switching, the electrical bridges and switches can alternatively be replaced by optical bridges 50 and switches 54 as shown in FIG. 2 within an optical switch board 28. The client transmitters and receivers must then be made for ITU grade long reach optical signals.

Self-healing

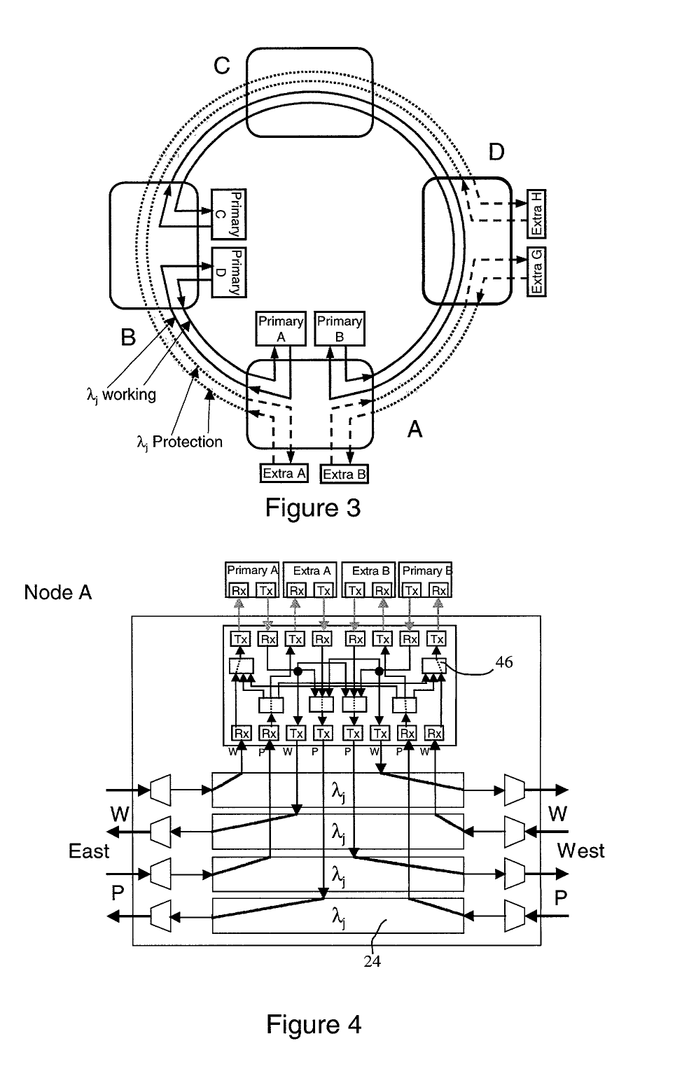

In the following sections, the embodiment of FIG. 1 is used to illustrate the optical channel shared protection function. FIG. 3 shows a four-node, four-fiber optical channel shared protection ring under the normal conditions. The four nodes represent four different types of node configurations using wavelength λⱼ. Node A adds and drops both primary (protected) and extra (pre-emptible) traffic. Node B adds and drops primary traffic and passes through extra traffic. Node D adds and drops extra traffic and passes through primary traffic. Node C passes through both primary and extra traffic. The connections inside the four nodes A, B, D, and C are shown in FIGS. 4, 5, 6 and 7, respectively.

For Node A, as shown in FIG. 4, all the four 2×2 switches are in the add/drop state. This allows both working and protection channels to be added to or dropped from the ring. The electronic switches connect primary clients to the working channels, and the extra clients to the protection channels.

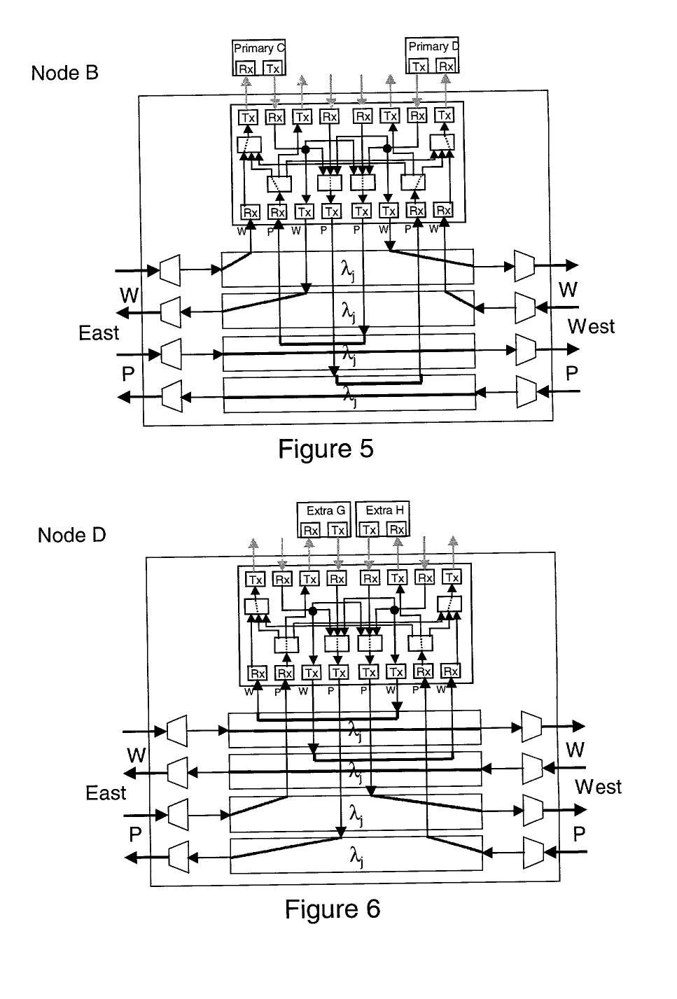

For Node B, as shown in FIG. 5, the two switches for the working channels are in the add/drop state, and two switches for the protection channels are in the pass-through state. This allows the primary traffic to be added or dropped, and the extra traffic to pass through. The two primary clients are connected to the working transmitters and receivers, and the two client interfaces for the extra clients are open.

For Node D, as shown in FIG. 6, the two switches for the protection channels are in the add/drop state, and two switches for the working channels are in the pass-through state. This allows the primary traffic to pass through, and the extra traffic to be added or dropped. The two extra clients are connected to the protection transmitters and receivers, and the two client interfaces for the primary traffic are open.

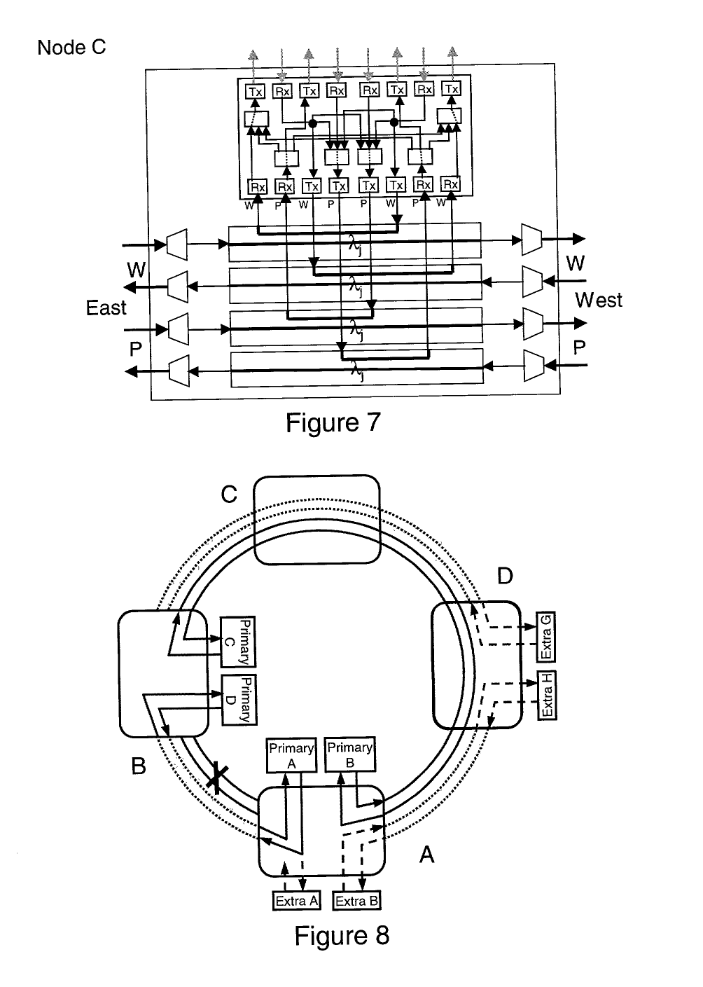

For Node C, as shown in FIG. 7, all the four switches are in the passthrough state. This lets both the working and protection channels to pass through. All the client interfaces for both the primary and extra traffic are open.

Fiber Cut

FIG. 8 shows an example of a fiber cut. The example fiber cut is on the working fibers between Nodes A and B. This fiber cut interrupts the primary connection between the clients Primary A and Primary D. To restore the connection, Nodes A and B perform a span switch as shown in FIG. 8.

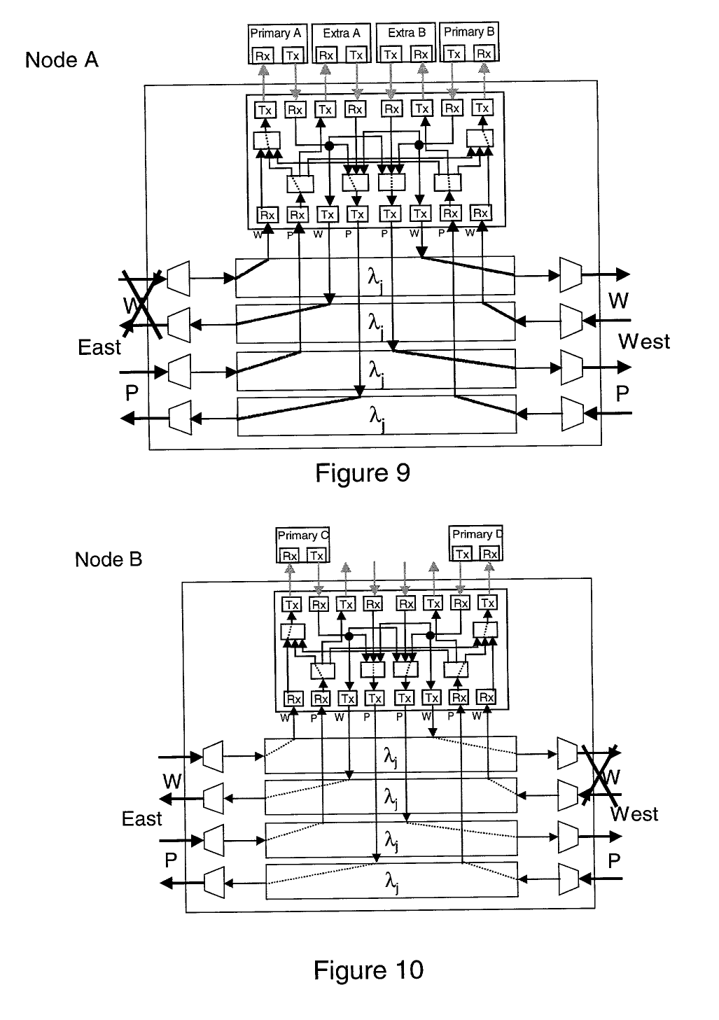

Node A drops the low priority client Extra A and switches the client Primary A to the protection fibers on the same span. The internal switching for Node A is shown in FIG. 9.

Node B performs a similar span switch to the protection channels. The two protection 2×2 switch fabrics switch to add/drop state as shown in FIG. 10.

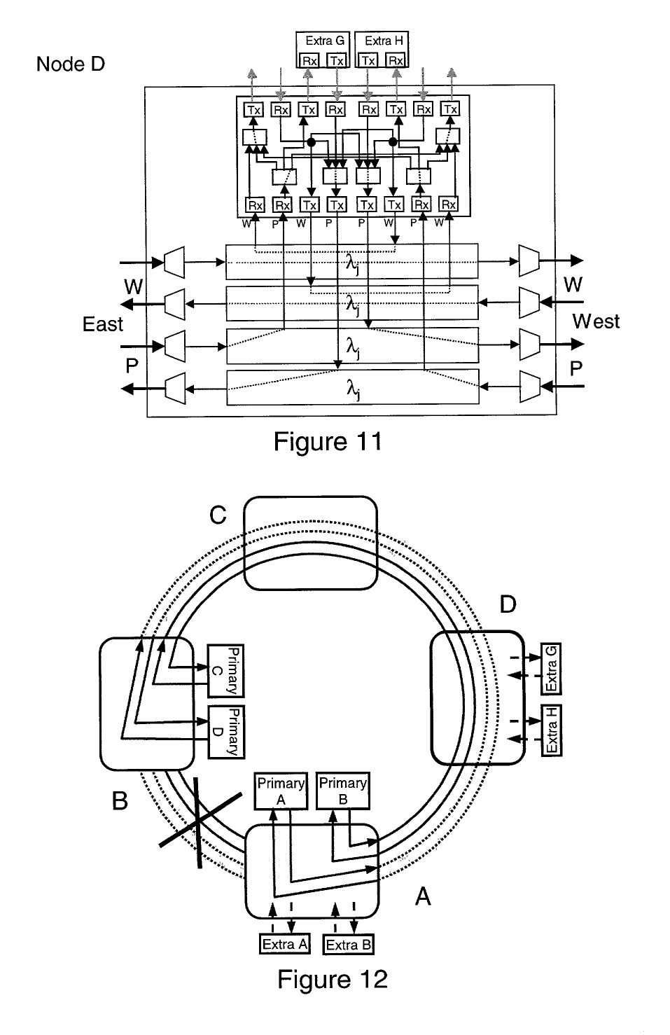

To avoid traffic misconnection, client Extra G in Node D switches to open state as indicated in FIG. 11.

Node C stays unchanged.

Cable Cut

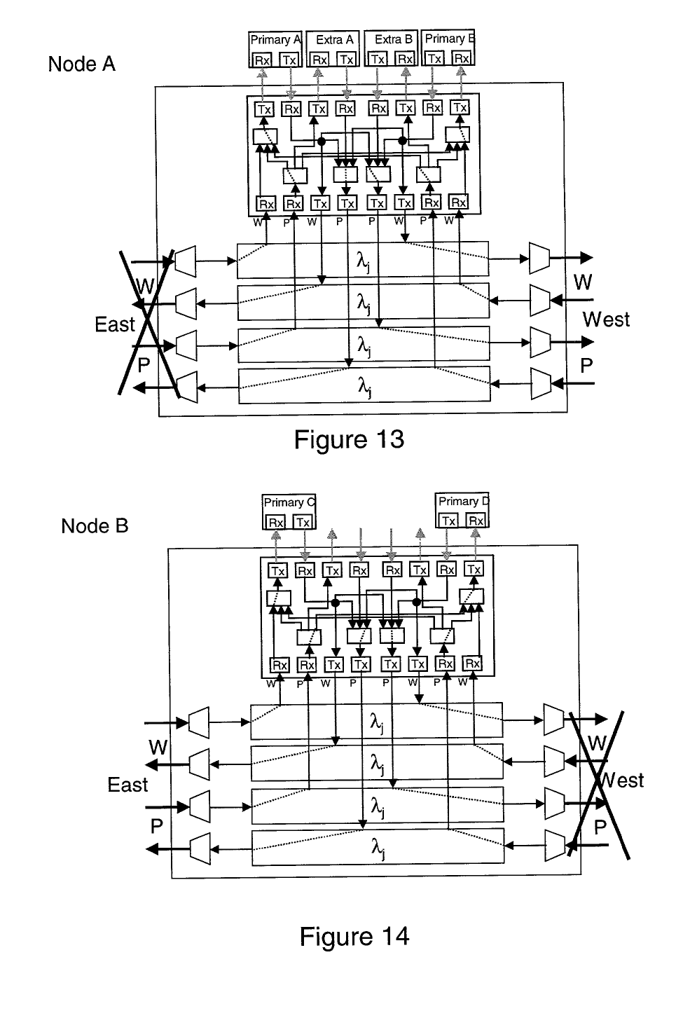

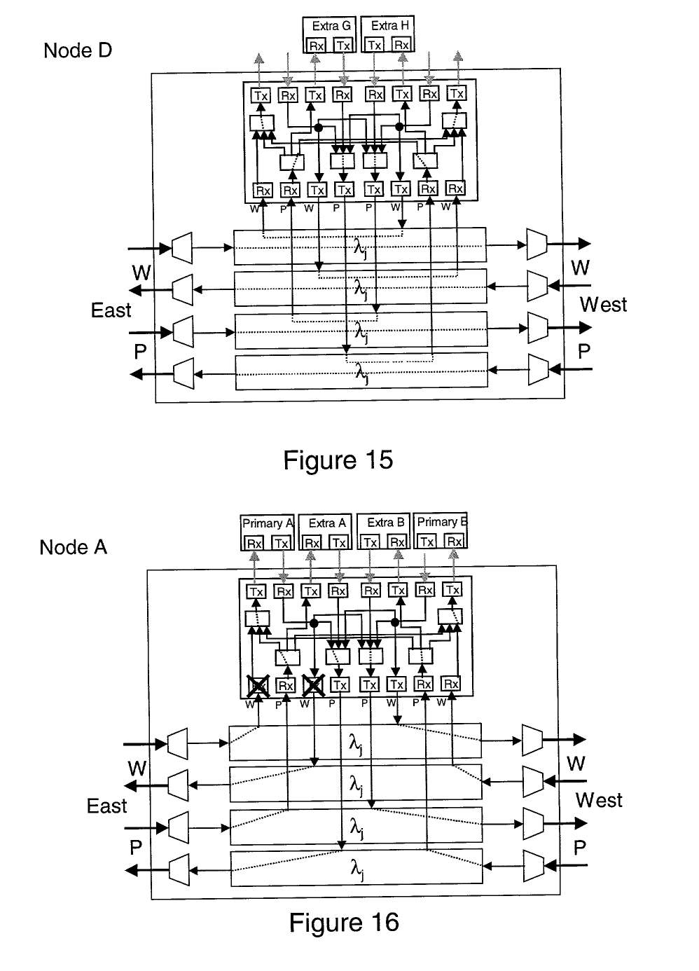

FIG. 12 shows a case where the cable between Nodes A and B is cut. This cable cut interrupts the connection between the clients Primary A and D. To heal this cable cut, Nodes A and B perform a ring switch to the protection channels away from the cut as shown in FIG. 12. The extra traffic connections between Nodes A and D are interrupted before the ring switch to avoid traffic misconnection. This is done by disconnecting the incoming protection channels from the extra clients in Nodes A and D, as shown in FIGS. 13 and 15, respectively. For the ring switch, Node A (FIG. 13) bridges the signal from the client Primary A to the outgoing protection channel, and sends the signal from the incoming protection channel to Primary A. No change is required in the 2×2 optical switches in Node A. Node B (FIG. 14) bridges the signal from the client Primary D to the outgoing protection channel, and switches the signal from the incoming protection channel to the client Primary D. Then Node B changes the two 2×2 protection switches to the add/drop state. Node D (FIG. 15) lets the protection channels to pass through. No change is needed for Node C, since it is already in the pass through state.

Component Failures

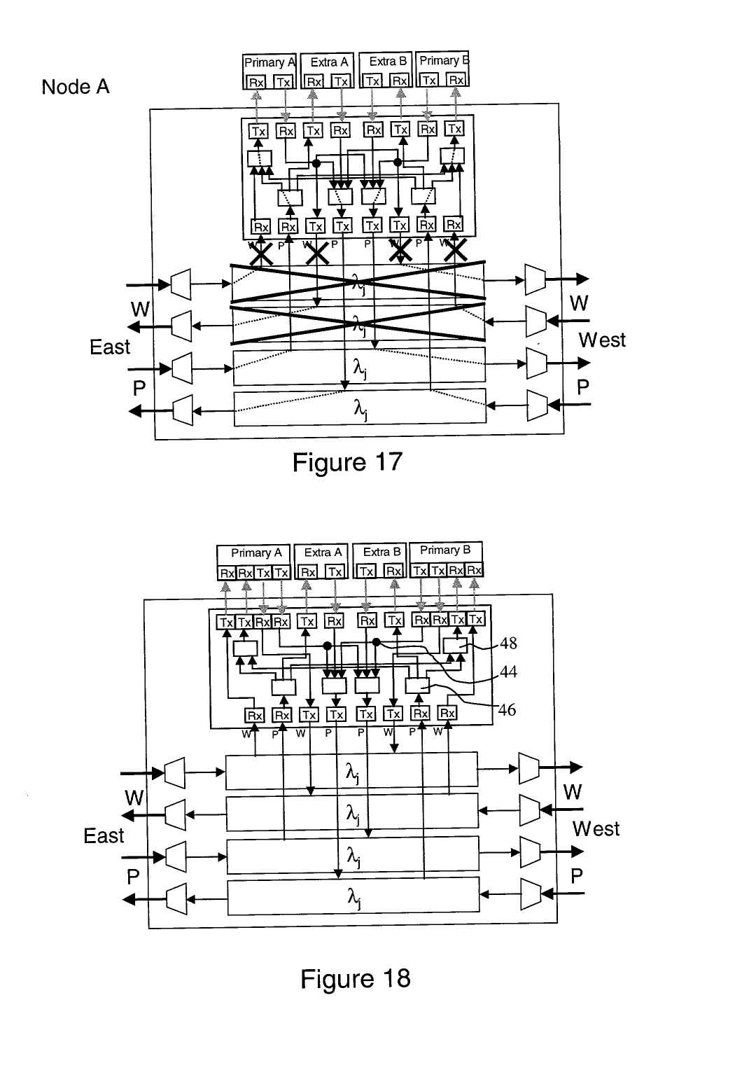

In addition to fiber and cable cuts, the architectures of the present invention can heal failures in components, such as failures in transmitters and receivers for long-reach optical signals, or failures in the 2×2 optical switch fabric. FIG. 16 shows a failure of the working long-reach transmitter and receiver for the client Primary A. The failure can be healed by a span switch between Nodes A and B as described above with respect to FIGS. 9-11. The same protection process can be used to heal failure in the link from the 2×2 switch fabrics to the electronic switch board and a failure in the 2×2 switch fabrics, as shown in FIG. 17.

Further Embodiments

The architectures described above with reference to FIGS. 1 and 2 have single points of failure. For example, in FIG. 1, the 1×3 electronic switches and bridges connecting the working channels, and the working short-reach transmitters and receivers connected to the primary clients can be a single point of failure. Also, the optical 1×3 switches and bridges connecting the working channels in FIG. 2 are subject to single point failure.

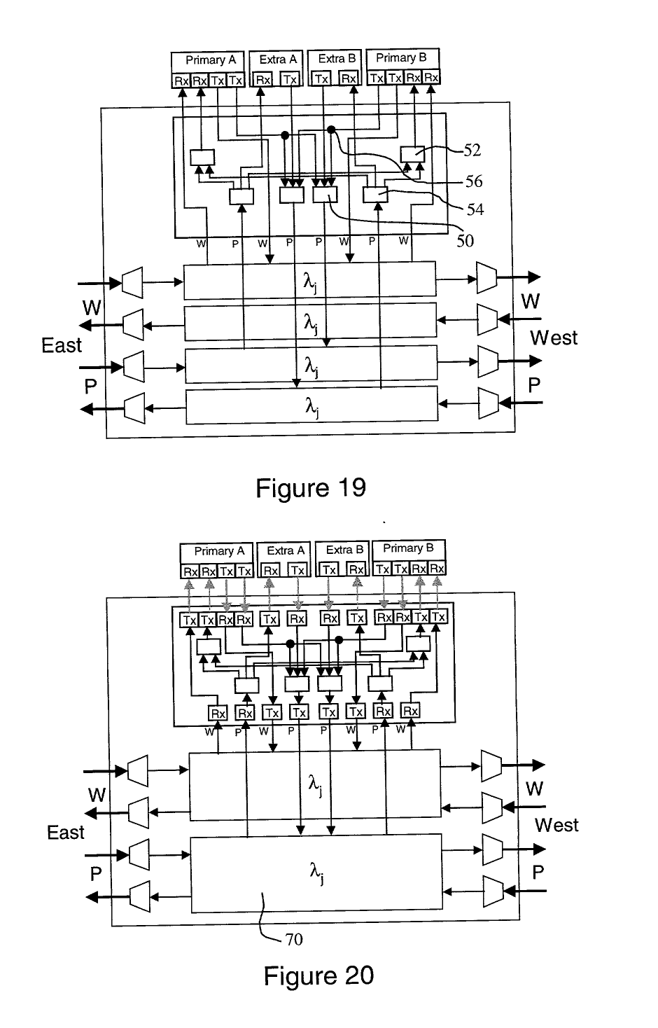

The architecture shown in FIG. 18 avoids such single point failures. In this architecture, relative to the architecture shown in FIG. 1, the 1×3 electronic switches and bridges connecting to the working channels are replaced by 1×2 electronic switches and bridges, and the working channels are connected directly between the working long- and short-reach transmitters and receivers without going through any switch. One more pair of short-reach transmitter and receiver is added for each primary client. This arrangement provides the primary clients with a working and a protection signal to choose from. This architecture can heal any single component failure inside the node. But it is costs more than the architecture in FIG. 1, because additional transmitters and receivers are needed. An optical version of this architecture having no single point failure is shown in FIG. 19.

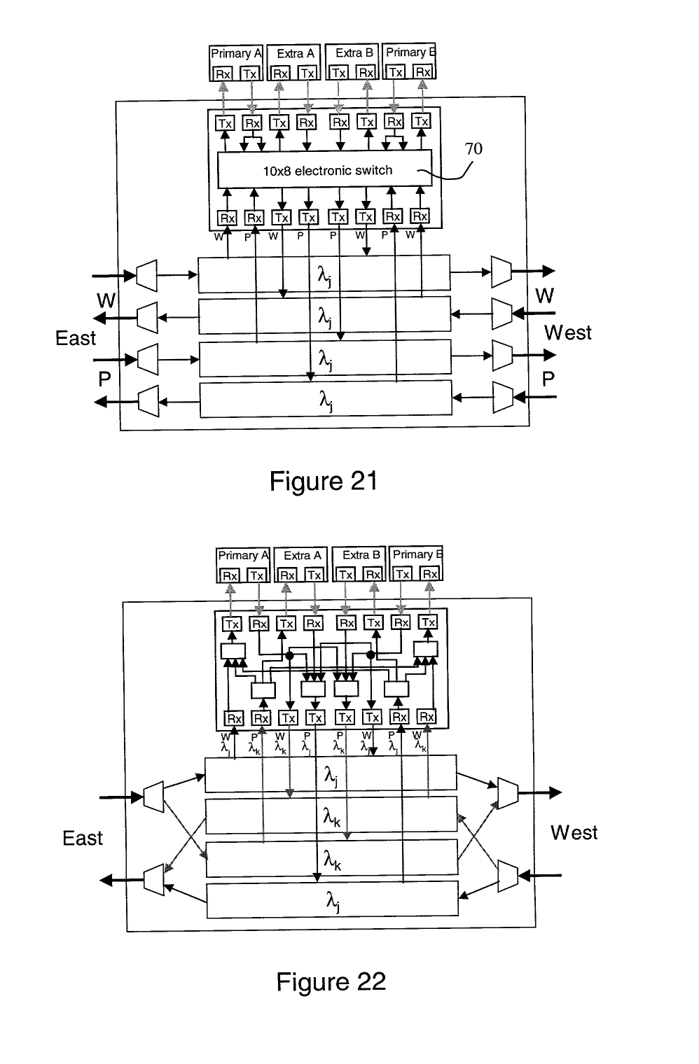

All the architectures described above use 2×2 optical switch fabrics. Larger optical switch fabrics, for example 4×4 and 8×8, can of course be used to achieve same or greater functionality. FIG. 20 is an example that has the same functionality as the architecture shown in FIG. 18, where the four 2×2 optical switch fabrics are replaced by two 4×4 optical switches 70. Larger electronic fabrics can also be used. FIG. 21 is an architecture of using 8×10 electronic switch fabric 72. But the 8×10 electronic fabric can be a single point of failure.

The architectures described above may also be implemented, with some variation, in the form of a two-fiber ring, by using a second wavelength on each fiber as if it were a second pair of fibers.

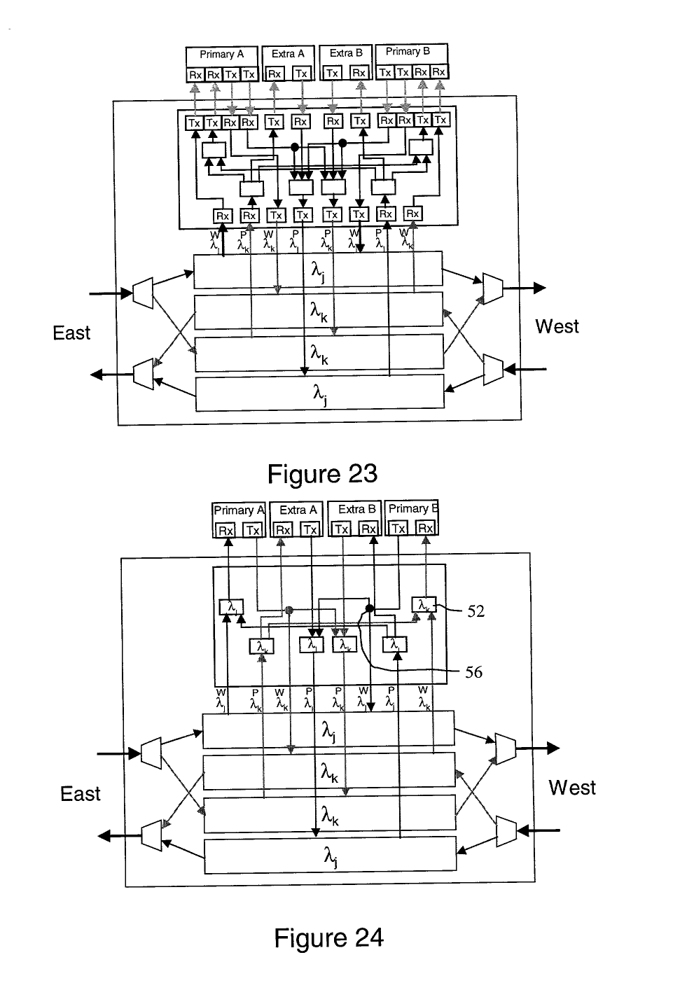

In a two-fiber ring, two wavelengths are required to support bi-directional connections. FIG. 22 shows a two-fiber architecture with 2×2 optical switches and 1×3 electronic bridges and switches. In this architecture, a ring switch is performed on the same wavelength, but a span switch must switch between two different wavelengths. The architecture supports wavelength conversion, because protection switching is done at the electronic level. FIG. 23 is an architecture similar to FIG. 22, but without the risk of single point failure.

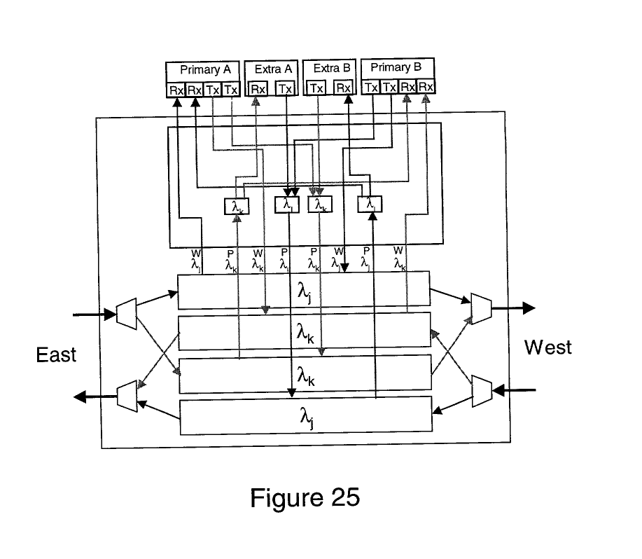

The same as for the four-fiber ring, the electronic switches and bridges in FIGS. 22 and 23 can be replaced by optical bridges and switches. FIG. 24 shows an optical version of the architecture in Figure A. Because wavelength conversion is not possible in this architecture, 1×2 optical bridges and switches are used in FIG. 24. As a result, the span switch is not supported. FIG. 25 is a modified architecture of FIG. 24 to avoid single point of failure.

The four-fiber hybrid optical channel (or two-fiber, two-wavelength) switched shared protection ring architectures of the present invention use a combination of small size optical switches such as 2×2 and 4×4 with small size electronic switch fabrics and bridges or with optical switch fabrics and bridges such as 1×2 and 1×3. The architectures can be designed to provide protection against any single point of failure such fiber or cable cut, and component failures such as transmitter, receiver, electronic and optical switch fabric.

It will be apparent to those skilled in the art that various modifications and variations can be made to the present invention without departing from the spirit and scope of the invention. For example, the individual 2×2 or 4×4 switch fabrics may be formed together as a unit. Larger electronic fabrics me be used as well. A 2×6 may replace two 1×3's, for example. Thus, it is intended that the present invention cover the modifications and variations of this invention provided they come within the scope of the appended claims and their equivalents.

What is claimed is:

1. A node device for an optical shared protection ring, the ring utilizing four fibers in the ring, the device comprising:
four two-by-two optical switches each arranged to be optically connected in-line to a respective one of four fibers in a ring;
four pairs of long-reach optical transmitters and receivers, each pair optically connected to a respective one of the four two-by-two optical switches; and
at least four pairs of short-reach optical transmitters and receivers arranged communicate electrically with selectable ones of said four pairs of long-reach optical transmitters;
wherein said device is structured and arranged so as to be able to provide non-adjacent-node protection switching when connected in an optical shared protection ring.

2. The device of claim 1 further comprising:
at least six pairs of short-reach optical transmitters and receivers arranged communicate electrically with selectable ones of said four pairs of long-reach optical transmitters, wherein said device is structured and arranged such that no single component failure will cause failure of the device.

3. The device of claim 1 further comprising:
an electrical board selectably connecting the long-reach transmitters and receivers with the short-reach receivers and transmitters, respectively, the electrical board including a plurality of one-by-three electrical switches and a plurality of one-by-three electrical bridges.

4. The device of claim 3 wherein the electrical board includes no electrical switch in the communications path exceeding one-by-three in size, and no electrical bridge in the communications path exceeding one-by-three in size.

5. The device of claim 3 wherein the electrical board includes at least six one-by-three electrical switches and at least two one-by-three electrical bridges in the communications path.

6. A node device for an optical shared protection ring, the ring utilizing at least each of two wavelengths on each of two fibers in the ring, one wavelength as a working wavelength and one wavelength as a protection wavelength, the device comprising:
four two-by-two optical switches each arranged to be optically connected in-line to a respective one of said two wavelengths on a respective one of said two fibers;
four pairs of long-reach optical transmitters and receivers, each pair optically connected to a respective one of the four two-by-two optical switches; and
at least four pairs of short-reach optical transmitters and receivers arranged communicate electrically with selectable ones of said four pairs of long-reach optical transmitters;
wherein said device is structured and arranged so as to be able to provide non-adjacent-node protection switching when connected in an optical shared protection ring.

7. The device of claim 6 further comprising:
at least six pairs of short-reach optical transmitters and receivers arranged communicate electrically with selectable ones of said four pairs of long-reach optical transmitters, wherein said device is structured and arranged such that no single component failure will cause failure of the device.

8. The device of claim 6 further comprising:
an electrical board selectably connecting the long-reach transmitters and receivers with the short-reach receivers and transmitters, respectively, the electrical board including a plurality of one-by-three electrical switches and a plurality of one-by-three electrical bridges.

9. The device of claim 8 wherein the electrical board includes no electrical switch in the communications path exceeding one-by-three in size, and no electrical bridge in the communications path exceeding one-by-three in size.

10. The device of claim 8 wherein the electrical board includes at least six one-by-three electrical switches and at least two one-by-three electrical bridges in the communications path.

11. A node device for an optical shared protection ring, the ring utilizing four fibers in the ring, the device comprising:
four two-by-two optical switches each arranged to be optically connected in-line to a respective one of four fibers in a ring; and
an optical switch board connected to said four two-by-two optical switches, the optical switch board including a plurality of one-by-three optical switches and a plurality of one-by-three optical bridges arranged for selectably connecting said four two-by-two optical switches to a selected optical add port or a selected optical drop port;
wherein said device is structured and arranged so as to be able to provide non-adjacent-node protection switching when connected in an optical shared protection ring.

12. The device of claim 11, wherein said optical switch board includes at least four one-by-three optical switches and at least two one-by-three optical bridges.

13. The device of claim 12, wherein said optical switch board includes exactly four one-by-three optical switches and a least two one-by-three optical bridges.

14. The device of claim 11, wherein said optical switch board includes no optical switches larger than one-by-three and no optical bridges larger than one-by-three.

15. A node device for an optical shared protection ring, the ring utilizing at least each of two wavelengths on each of two fibers in the ring, one wavelength as a working wavelength and one wavelength as a protection wavelength, the device comprising:
optical switches each arranged to be optically connected in-line to a respective one of said two wavelengths on a respective one of said two fibers in a ring; and
an electrical or optical switch board connected to said optical switches, the switch board including one or more switches arranged for selectably connecting said optical switches to a selected optical add port or a selected optical drop port;
wherein said device is structured and arranged so as to be able to provide non-adjacent-node protection switching when connected in an optical shared protection ring.

16. The device of claim 15 wherein said selected add port is one of four add ports and said selected drop port is one of four drop ports.

17. The device of claim 15 wherein said selected add port is one of six add ports and said selected drop port is one of six drop ports and wherein the device and the optical switch board in the device are structured and arranged such that failure of a single component will not cause failure of the device.

18. The device of claim 15 wherein said optical switches are two four-by-four optical switches.

19. The device of claim 15 wherein said optical switches are four two-by-two switches.

20. The device of claim 15, wherein said switch board includes at least four one-by-three switches and at least two one-by-three bridges.

21. The device of claim 20 wherein said switch board includes exactly four one-by-three switches and a exactly two one-by-three bridges.

22. The device of claim 15, wherein said switch board includes no switches larger than one-by-three and no bridges larger than one-by-three.

23. A node device for an optical shared protection ring, the ring utilizing one of (1) four fibers and (2) at least each of two wavelengths on each of two fibers in the ring, one fiber pair or wavelength as a working fiber pair or wavelength, and one fiber pair or wavelength as a protection fiber pair or wavelength, the device comprising:
ring-side optical switches of no larger size than N×N; and
one of add-drop-side electrical or add-drop side optical switches of no larger size than MxO,
wherein N=4 and M=2 and O=6.

24. The device of claim 23 wherein N=2.

25. The device of claim 23 wherein M=1 and O=3.

26. The device of claim 23, the components of the device being structured and arranged such that failure of a single component does not cause failure of the device.

27. A node device for one of (1) a four-fiber and (2) a two-fiber, two-wavelength, optical channel switched protection ring architecture comprising nodes, the device having two-by-two optical switch fabrics, and one-by-three optical or electronic switches and bridges.

28. The device of claim 27 wherein the components of said device are adapted and arranged to provide non-adjacent node protection switching.

29. The device of claim 27 wherein the components of said device are adapted and arranged to prevent failure of the device on failure of a single of said components.
